(19) United States
(12) Patent Application Publication
(10) Pub. No.: US 2021/0091609 A1
(43) Pub. Date: Mar. 25, 2021

(54) STATOR OF ROTATING ELECTRICAL MACHINE AND STATOR MANUFACTURING METHOD

(71) Applicant: Mitsubishi Electric Corporation, Chiyoda-ku, Tokyo (JP)

(72) Inventors: Hideyuki MAEDA, Tokyo (JP); Yuki IWAMURA, Tokyo (JP); Daisuke KANAMORI, Tokyo (JP); Masataka MURATA, Tokyo (JP); Daisuke SHIJO, Tokyo (JP)

(73) Assignee: Mitsubishi Electric Corporation, Chiyoda-ku, Tokyo (JP)

(21) Appl. No.: 16/630,543

(22) PCT Filed: Aug. 30, 2018
(86) PCT No.: PCT/JP2018/032060

§ 371 Date: Jan. 13, 2020

(30) Foreign Application Priority Data
Sep. 6, 2017 (JP) 2017-171015

(51) Int. Cl. H02K 1/14; H02K 15/12; H02K 3/34

(52) U.S. Cl. CPC H02K 1/148; H02K 3/34; H02K 15/12

(57) ABSTRACT

With a virtual plane defined as a plane that passes through end points of abutting ends of first brim portions of a back yoke portion and is perpendicular to side surfaces on both sides in a circumferential direction of a tooth portion, first inner circumferential surfaces on an inner side in a radial direction of the first brim portions are formed on an outer side in the radial direction with respect to the virtual plane, except for the end points. Insulation sheets are mounted to the side surfaces of the tooth portion. An insulation resin portion covers both end surfaces in an axial direction of the tooth portion, the first inner circumferential surfaces of the first brim portions, and second outer circumferential surfaces of second brim portions, and is molded integrally with the tooth portion, the back yoke portion, and the insulation sheets.

### TECHNICAL FIELD

The present disclosure relates to a stator of a rotating electrical machine and a stator manufacturing method that ensure a wide winding area and enable increase in the number of windings to be wound.

### BACKGROUND ART

In rotating electrical machines in recent years, in order to achieve size reduction and output increase, a stator is divided or cores connected via thin portions are opened, and wires are wound around teeth in a concentrated manner.

Thus, the slot space factor of windings in the stator is improved. Then, these members are fitted to manufacture the stator. Here, it is necessary to make insulation between the core and the winding. Therefore, in addition to an insulation coat formed on the winding, an insulation member is interposed between the core and the winding, to make insulation. In general, such an insulation member is manufactured by resin molding using a mold. In order to increase the slot space factor, it is necessary to make the resin members in the slots as thin as possible. However, in the case where the stacking height of the core is great, resin is not fully supplied during molding, so that it is difficult to form insulation members at parts covering the inner sides of the slots, and the cost increases.

Accordingly, a conventional insulator for a stator includes a resin molded portion and an insulation sheet connected to the resin molded portion and located so as to cover at least a part of a circumferential-direction end surface of a tooth portion. The insulation sheet has a pair of slot walls for covering the circumferential-direction end surface of the tooth portion, and a connection wall for connecting the slot walls. The resin molded portion is molded integrally with the tooth portion and the insulation sheet so as to have a pair of wall portions that are opposed to the connection wall of the insulation sheet and a stacking-direction end surface of the tooth portion (see, for example, Patent Document 1).

### CITATION LIST

### Patent Document

Patent Document 1: Japanese Laid-Open Patent Publication No. 2016-116419

### SUMMARY OF THE INVENTION

### Problems to be Solved by the Invention

In the conventional stator of a rotating electrical machine, the thickness of an insulation member is small on side surfaces of the tooth portion covered by the insulation sheet. However, at an inner circumferential surface of a brim portion of a back yoke portion of a core, resin is supplied and molded, and if the stacking height of the core is great, the thickness of the resin member needs to be increased, thus causing a problem that the area of the slot is narrowed. This problem is particularly significant in a small-sized motor having a narrow slot area because the influence of the thickness of the insulation member insulating the inner circumferential surface of the brim portion is great in such a small-sized motor.

The present disclosure has been made to solve the above problem, and an object of the present disclosure is to provide a stator of a rotating electrical machine and a stator manufacturing method that ensure a wide winding area and enable increase in the number of windings to be wound, thus improving performance of the rotating electrical machine.

### Solution to the Problems

A stator of a rotating electrical machine according to the present disclosure is a stator of a rotating electrical machine, including a plurality of stator pieces arranged in an annular shape, the stator pieces each having a core, a winding body, and insulation sheets and an insulation resin portion that insulate the core and the winding body from each other. The core is formed by stacking a plurality of sheet materials in an axial direction, and has a back yoke portion and a tooth portion. The back yoke portion forms an outer circumferential part of the stator and has first brim portions protruding in a circumferential direction. The tooth portion protrudes inward in a radial direction from the back yoke portion and has, at an end on an inner side in the radial direction, second brim portions protruding in the circumferential direction. With a virtual plane defined as a plane that passes through end points on an inner side in the radial direction of circumferential-direction end surfaces of the first brim portions of the back yoke portion and is perpendicular to side surfaces on both sides in the circumferential direction of the tooth portion, first inner circumferential surfaces on an inner side in the radial direction of the first brim portions of the back yoke portion are formed on an outer side in the radial direction with respect to the virtual plane, except for the end points. The insulation sheets are mounted to the side surfaces of the tooth portion. The insulation resin portion covers both end surfaces in the axial direction of the tooth portion, the first inner circumferential surfaces of the first brim portions, and second outer circumferential surfaces on an outer side in the radial direction of the second brim portions, and is molded integrally with the tooth portion, the back yoke portion, and the insulation sheets. The winding body is formed by winding a wire around the tooth portion with the insulation sheets and the insulation resin portion interposed therebetween.

A stator manufacturing method according to the present disclosure is a method for manufacturing the stator of the rotating electrical machine described above, the method including the steps of: stacking the sheet materials in the axial direction to form the core; mounting the insulation sheets to the core; molding insulation resin integrally with the core and the insulation sheets to form the insulation resin portion; and winding the wire around the tooth portion to form the winding body.

### Effect of the Invention

The stator of the rotating electrical machine and the stator manufacturing method according to the present disclosure ensure a wide winding area and enable increase in the number of windings to be wound, thus improving performance of the rotating electrical machine.

### BRIEF DESCRIPTION OF THE DRAWINGS

FIG. 1 is a perspective view showing the structure of a stator of a rotating electrical machine according to embodiment 1.

FIG. 2 is a perspective view showing the structure of a stator piece of the stator shown in FIG. 1.

FIG. 3 is a perspective view showing the structure of the stator piece shown in FIG. 2.

FIG. 4 is a front view showing the structure of the stator piece shown in FIG. 2.

FIG. 5 is a side view showing the structure of the stator piece shown in FIG. 2

FIG. 6 is a sectional view showing the structure of the stator piece shown in FIG. 4, taken along line A-A.

FIG. 7 is a plan view showing the structure of a core of the stator piece shown in FIG. 2.

FIG. 8 is a perspective view showing the structure in which insulation sheets are mounted to the core of the stator piece shown in FIG. 7.

FIG. 9 is a horizontal sectional view showing the structure of a molding mold used in a manufacturing method for the stator piece of the stator shown in FIG. 1.

FIG. 10 is a vertical sectional view showing the structure of the molding mold used in the manufacturing method for the stator piece of the stator shown in FIG. 1.

FIG. 11 is a perspective view showing the structure of a stator piece of a stator of a rotating electrical machine according to embodiment 2.

FIG. 12 is a front view showing the structure of the stator piece shown in FIG. 11.

FIG. 13 is a side view showing the structure of the stator piece shown in FIG. 11.

FIG. 14 is a sectional view showing the structure of the stator piece shown in FIG. 12, taken along line B-B.

FIG. 15 is a perspective view showing the structure in which insulation sheets are mounted to a core of the stator piece of the stator of the rotating electrical machine according to embodiment 2.

FIG. 16 is a perspective view showing the structure of a stator piece of a stator of a rotating electrical machine according to embodiment 3.

FIG. 17 is a front view showing the structure of the stator piece shown in FIG. 16.

FIG. 18 is a side view showing the structure of the stator piece shown in FIG. 16.

FIG. 19 is a sectional view showing the structure of the stator piece shown in FIG. 17, taken along line C-C.

FIG. 20 is a plan view showing the structure of the core of the stator piece shown in FIG. 16.

FIG. 21 is a perspective view showing the structure in which insulation sheets are mounted to the core of the stator piece shown in FIG. 20.

FIG. 22 is a side view showing another structure of the stator piece of the stator of the rotating electrical machine according to embodiment 3.

FIG. 23 is a sectional view showing the detailed structure of the stator piece shown in FIG. 22, taken along line D-D.

FIG. 24 is a perspective view showing the structure of a stator piece of a stator of a rotating electrical machine according to embodiment 4.

FIG. 25 is a front view showing the structure of the stator piece shown in FIG. 24.

FIG. 26 is a side view showing the structure of the stator piece shown in FIG. 24.

FIG. 27 is a sectional view showing the structure of the stator piece shown in FIG. 25, taken along line C-C.

FIG. 28 is a perspective view showing the structure in which insulation sheets are mounted to a core of the stator piece of the stator of the rotating electrical machine according to embodiment 5.

FIG. 29 is a horizontal sectional view showing the structure of a molding mold used in a manufacturing method for the stator piece shown in FIG. 24.

FIG. 30 is a sectional view showing the structure of a stator piece of a stator of a rotating electrical machine in another example of embodiment 5.

FIG. 31 is a sectional view showing the structure of a stator in a comparative example.

FIG. 32 is a perspective view showing the structure of a stator piece of a stator according to embodiment 5.

FIG. 33 is a front view showing the structure of the stator piece shown in FIG. 32.

FIG. 34 is a side view showing the structure of the stator piece shown in FIG. 32.

FIG. 35 is a sectional view showing the structure of the stator piece shown in FIG. 33, taken along line E-E.

FIG. 36 is a plan view showing the structure of a core of the stator piece shown in FIG. 32.

FIG. 37 is a perspective view showing the structure in which insulation sheets are mounted to the core of the stator piece shown in FIG. 32.

FIG. 38 is a sectional view showing the detailed structure of the stator piece shown in FIG. 34, taken along line F-F.

FIG. 39 shows a manufacturing method for the stator piece of the stator shown in FIG. 32.

FIG. 40 shows the manufacturing method for the stator piece of the stator shown in FIG. 32.

### DESCRIPTION OF EMBODIMENTS

### Embodiment 1

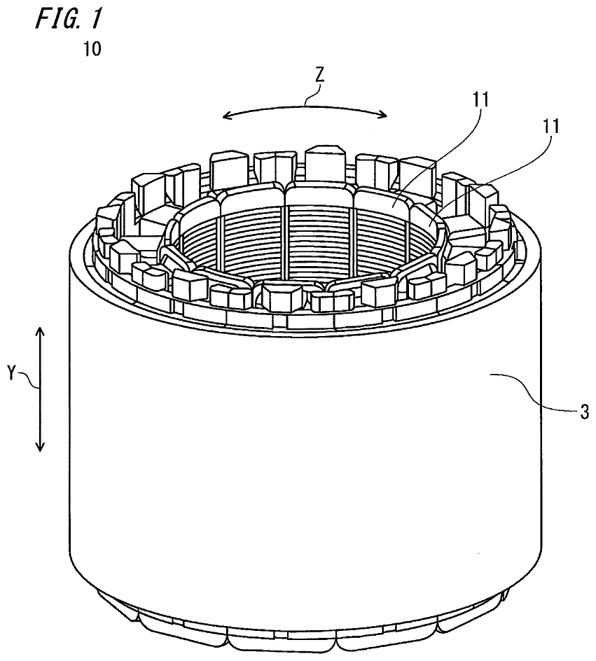

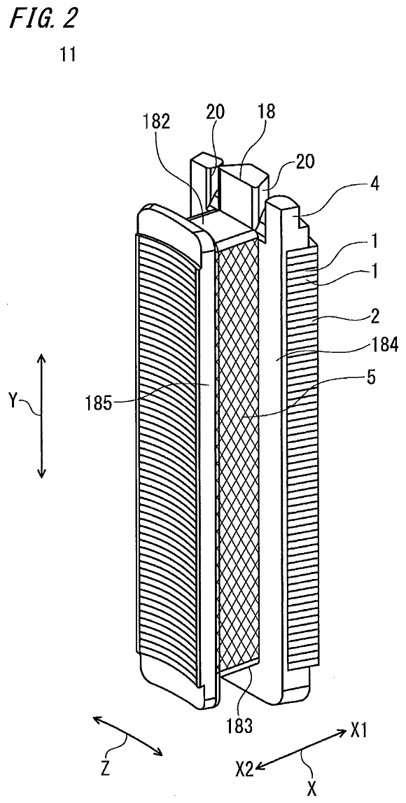

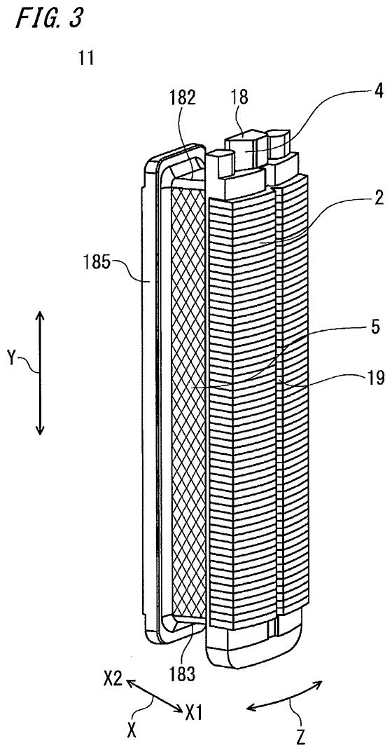

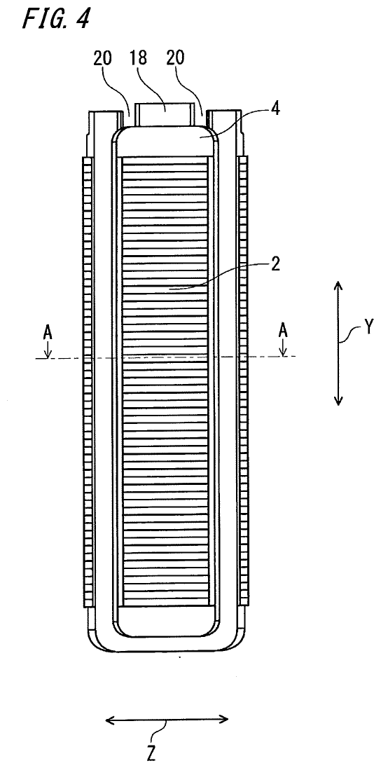

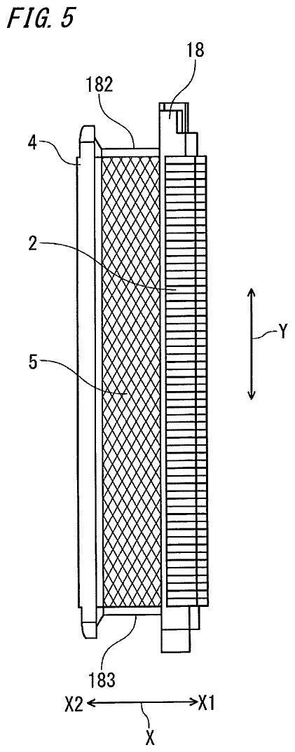

Hereinafter, embodiments of the present disclosure will be described. FIG. 1 is a perspective view showing the structure of a stator of a rotating electrical machine according to embodiment 1. FIG. 2 is a perspective view showing the structure of a stator piece of the stator shown in FIG. 1. FIG. 3 is a perspective view showing the structure of the stator piece shown in FIG. 2. FIG. 4 is a front view showing the structure of the stator piece shown in FIG. 2. FIG. 5 is a side view showing the structure of the stator piece shown in FIG. 2.

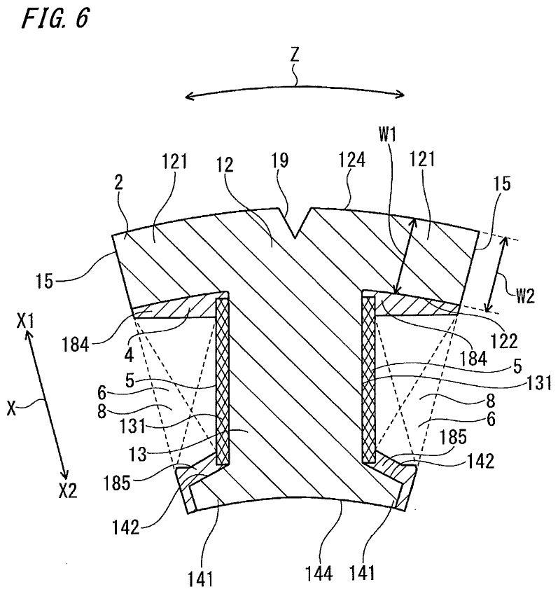

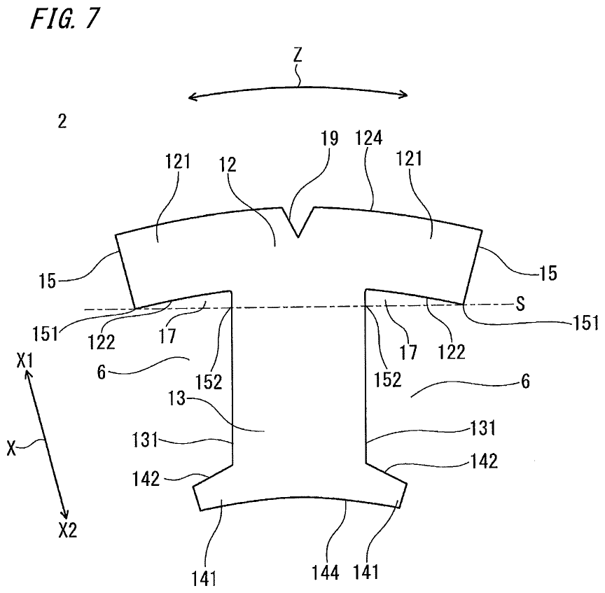

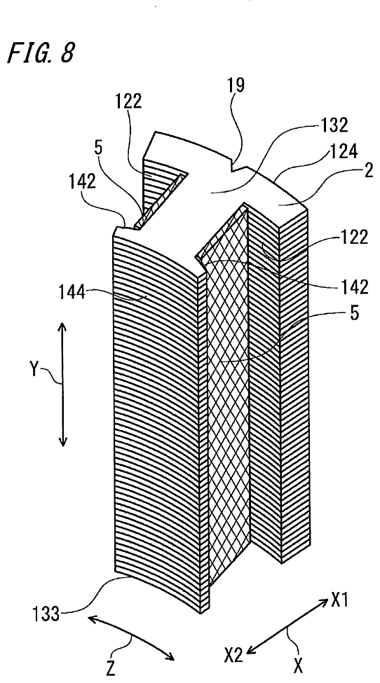

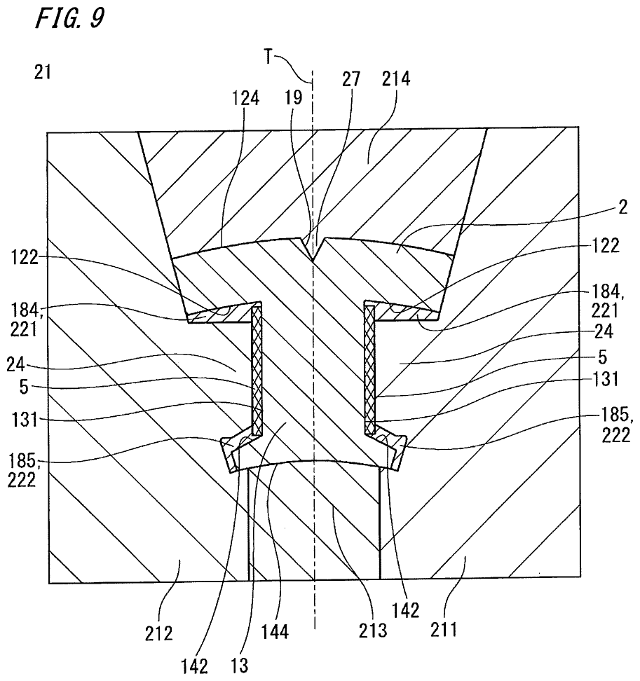

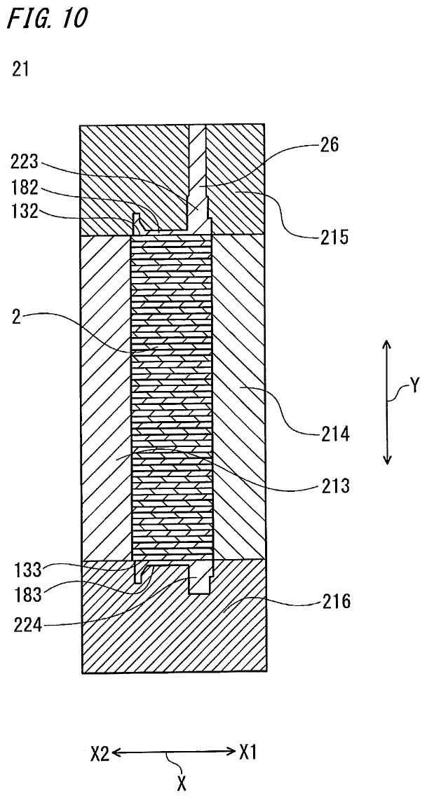

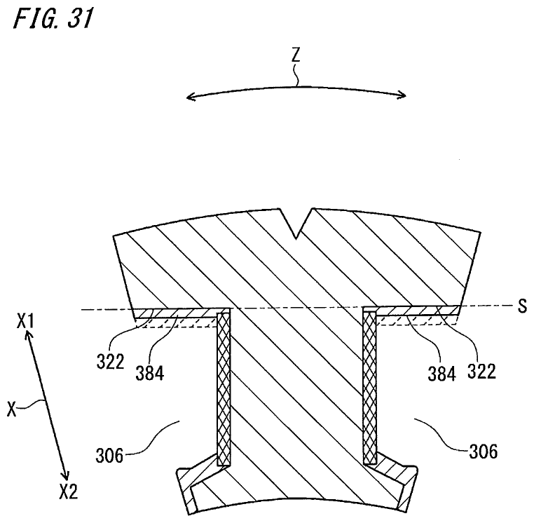

FIG. 6 is a sectional view showing the structure of the stator piece shown in FIG. 4, taken along line A-A. FIG. 7 is a plan view showing the structure of a core of the stator piece shown in FIG. 2. FIG. 8 is a perspective view showing the structure in which insulation sheets are mounted to the core of the stator piece shown in FIG. 7. FIG. 9 is a horizontal sectional view showing the structure of a molding mold used in a manufacturing method for the stator piece of the stator shown in FIG. 1. FIG. 10 is a vertical sectional view showing the structure of the molding mold used in the manufacturing method for the stator piece of the stator shown in FIG. 1. FIG. 31 is a sectional view showing the structure of a stator piece in a comparative example.

In the following description, directions in a stator 10 of a rotating electrical machine are defined as a circumferential direction Z, an axial direction Y of a rotary shaft with which the rotating electrical machine rotates, a radial direction X, an outer side X1 in the radial direction X, and an inner side X2 in the radial direction X. Therefore, also for parts composing the stator 10 and the manufacturing method therefor, directions are indicated using the above defined directions as references.

In the drawing, the stator 10 of the rotating electrical machine (hereinafter, referred to as stator 10) is composed of a plurality of stator pieces 11 and a frame 3. In the stator 10, the plurality of stator pieces 11 are arranged in an annular shape. Each stator piece 11 has one tooth portion 13. The frame 3 is formed so as to cover the entire circumference on the outer side X1 in the radial direction X of the plurality of stator pieces 11 arranged in an annular shape.

The stator piece 11 includes a core 2, a winding body 8, and insulation sheets 5 and an insulation resin portion 4 that serve as an insulator for insulating the core 2 and the winding body 8 from each other. The core 2 is formed by stacking, in the axial direction Y, a plurality of sheet materials 1 stamped from a steel sheet having magnetic property such as an electromagnetic steel sheet. As shown in FIG. 7, the core 2 has a back yoke portion 12 and a tooth portion 13. The back yoke portion 12 forms an outer circumferential part of the stator 10. The back yoke portion 12 has first brim portions 121 protruding toward both sides in the circumferential direction Z. The tooth portion 13 is formed so as to protrude from the back yoke portion 12 toward the center on the inner side X2 in the radial direction X.

The tooth portion 13 has, at an end on the inner side X2 in the radial direction X of the tooth portion 13, second brim portions 141 protruding toward both sides in the circumferential direction Z. The back yoke portion 12 and the tooth portion 13 formed as described above form slot portions 6 in a recess shape on both sides in the circumferential direction Z of the tooth portion 13. The end surfaces of the first brim portions 121 of the back yoke portion 12 form abutting ends 15, and when the plurality of stator pieces 11 are arranged in an annular shape, the abutting ends 15 come into contact with each other to form an annular magnetic path. The tooth portion 13 has, on both sides in the circumferential direction Z, side surfaces 131 extending in the axial direction Y and having a rectangular shape. The insulation sheets 5 are mounted to the side surfaces 131 of the tooth portion 13.

In the description, other surfaces are referred to as follows (see FIG. 7 and FIG. 8). A surface located at the upper end in the axial direction Y of the tooth portion 13 and connecting to the side surfaces 131 is referred to as upper surface 132. A surface located at the lower end in the axial direction Y of the tooth portion 13 and connecting to the side surfaces 131 is referred to as lower surface 133. A surface located on the outer side X1 in the radial direction X of the back yoke portion 12 and extending in the axial direction Y is referred to as first outer circumferential surface 124. A surface located on the inner side X2 in the radial direction X of each first brim portion 121 of the back yoke portion 12 and extending in the axial direction Y is referred to as first inner circumferential surface 122. A surface located on the outer side X1 in the radial direction X of each second brim portion 141 and extending in the axial direction Y is referred to as second outer circumferential surface 142. A surface located on the inner side X2 in the radial direction X of the tooth portion 13 and extending in the axial direction Y is referred to as second inner circumferential surface 144.

With a virtual plane S defined as a plane that extends in the axial direction Y and that passes through end points 151 on the inner side X2 in the radial direction X of the abutting ends 15 and is perpendicular to the side surfaces 131 of the tooth portion 13, the first inner circumferential surface 122 of the first brim portion 121 is formed to be located on the outer side X1 in the radial direction X with respect to the virtual plane S, except for the end points 151. Therefore, each side surface 131 of the tooth portion 13 extends toward the outer side X1 in the radial direction X with respect to an intersection 152 with the virtual plane S, so as to connect to the first inner circumferential surface 122. An area surrounded by the virtual plane S, the first inner circumferential surface 122, and a part of the side surface 131 is referred to as undercut portion 17.

The first outer circumferential surface 124 of the back yoke portion 12 has a positioning groove 19 extending in the axial direction Y. The positioning groove 19 is used for positioning the core 2 in various situations such as a molding step, a winding step, an annular arrangement step, a shrinkage-fit step, and conveyance.

The insulation resin portion 4 is formed by being molded integrally with the core 2 and the insulation sheets 5 mounted to the side surfaces 131 of the tooth portion 13. The insulation resin portion 4 includes a winding frame portion 18 and lead-in/out portions 20 through which a winding-start end and a winding-finish end of a wire of the winding body 8 to be wound around the winding frame portion 18 are led in and out. The winding frame portion 18 has an upper wall 182 covering the upper surface 132 of the tooth portion 13, a lower wall 183 covering the lower surface 133, an outer flange 184 covering the first inner circumferential surface 122 of the first brim portion 121, and an inner flange 185 covering the second outer circumferential surface 142 of the second brim portion 141.

The winding body 8 is formed by winding a wire around the tooth portion 13. Since the winding body 8 is formed in this way, the winding body 8 and the core 2 are electrically insulated from each other in the slot portions 6 by the insulation sheets 5 and the insulation resin portion 4. In FIG. 6, regarding the winding body 8, only the formation area thereof is shown by dotted lines. Also in the other embodiments below, the winding body 8 is formed in the same manner, and therefore illustration of the winding body 8 is omitted in the drawings or only the formation area thereof is shown by dotted lines as in FIG. 6.

In the drawings, the insulation sheets 5 are shown by hatching also in views other than a sectional view, for the purpose of clarifying the mounting area thereof. Although the insulation sheets 5 are formed from an extremely thin member as described below, the insulation sheets 5 are shown in an appropriate thickness so as to clarify the parts where the insulation sheets 5 are formed, in the drawings. Also in the other embodiments below, the insulation sheets are shown in the same manner in the drawings.

Here, specific examples of the insulation resin portion 4 and the insulation sheet 5 will be described. The insulation resin portion 4 is formed from a thermoplastic resin such as polybutylene terephthalate (PBT), liquid crystal plastic (liquid crystal polyester) (LCP), polyphenylene sulfide (PPS), or polyacetal (POM). The insulation sheet 5 is a sheet-shaped insulator made from a thermoplastic resin such as polyethylene terephthalate (PET) or polyphenylene sulfide resin (PPS). In general, the thickness of the insulation sheet 5 is set to about 0.03 mm to 0.30 mm. Decreasing the thickness of the insulation sheet 5 expands the area where a winding can be made, leading to improvement in performance of the rotating electrical machine, but insulation property is reduced. Therefore, the thickness is selected as appropriate in accordance with required insulation property.

Further, since the insulation sheet 5 is mounted between the winding body 8 and the core 2, the insulation sheet 5 serves to transfer heat generated in the winding body 8 during current application, to the core 2, so as to dissipate the heat to outside of the rotating electrical machine. The heat transfer amount in heat conduction is in inverse proportion to the thickness of a material and is in proportion to the thermal conductivity thereof. Therefore, heat dissipation property can be improved by reducing the thickness of the insulation sheet 5 or using a material having a high thermal conductivity. The thermal conductivity of a material such as PET used for the insulation sheet 5 as described above is about 0.15 (W/mK), and the thermal conductivity of a material such as LCP used for the insulation resin portion 4 is about 0.4 (W/mK). Therefore, the thermal conductivity of the insulation sheet is lower than that of the insulation resin portion. If the insulation resin portion is replaced with the insulation sheet having the same thickness as the insulation resin portion, heat dissipation property is deteriorated. In order not to deteriorate heat dissipation property, it is desirable that the thermal conductivity of the insulation sheet 5 is equal to or greater than the thermal conductivity of the material of the insulation resin portion 4. For example, by using, for the insulation sheet 5, silicone rubber (thermal conductivity: 0.8 (W/mK) to 2.5 (W/mK)) in which a special filler is blended for improving heat dissipation property as compared to the material of the insulation resin portion 4, heat dissipation property can be greatly improved.

However, as compared to a member made of PET or the like, a member made of silicone rubber as described above has lower rigidity and thus is readily deformed. In the case of silicone rubber, it is impossible to make a crease in advance. Therefore, at the time of attachment, it is necessary to use a jig for, for example, adhering the insulation sheet 5 at a desired location in advance for attachment so that the insulation sheet 5 is not folded at another location.

Next, a method for manufacturing the stator 10 according to embodiment 1 configured as described above will be described. First, the insulation sheet 5 is cut in a predetermined shape from a base material. With an adhesive agent applied to the side surface 131 of the tooth portion 13, the insulation sheet 5 is attached to the side surface 131 (see FIG. 8). Alternatively, an adhesive agent may be applied to the insulation sheet 5 in advance and then the insulation sheet 5 may be bonded and attached to the side surface 131 of the core 2. In this case, an adhesive agent application step can be omitted, leading to decrease in the number of steps.

Here, the method in which the insulation sheet 5 is attached to the core 2 in advance has been shown, but without limitation thereto, after the core 2 is placed in the molding mold 21 for molding the insulation resin portion 4 described later, the insulation sheets 5 may be placed at predetermined locations, and in this state, the insulation resin portion 4 may be molded integrally therewith.

Next, the insulation resin portion 4 is molded on the core 2. The molding mold 21 used for molding the insulation resin portion 4 is shown in FIG. 9 and FIG. 10. FIG. 9 and FIG. 10 show a state in which the molding mold 21 is clamped and is filled with insulation resin. First, the structure of the molding mold 21 will be described. The molding mold 21 is composed of a right die 211, a left die 212, a front die 213, a rear die 214, an upper die 215, and a lower die 216. These dies are merely referred to in accordance with their locations in the drawings, and are not limited to this example.

As shown in FIG. 9, the right die 211 and the left die 212 are located so as to be opposed to the side surfaces 131 of the tooth portion 13. The right die 211 and the left die 212 have projections 24 corresponding to the slot portions 6 at the side surfaces 131 of the tooth portion 13. Each insulation sheet 5 is held between the projection 24 and the side surface 131 of the tooth portion 13. An outer cavity 221 for forming the outer flange 184 of the insulation resin portion 4 is formed between the first inner circumferential surface 122 of the core 2 and each of the right die 211 and the left die 212. An inner cavity 222 for forming the inner flange 185 of the insulation resin portion 4 is formed between the second outer circumferential surface 142 of the core 2 and each of the right die 211 and the left die 212.

The front die 213 is a die for supporting the second inner circumferential surface 144 of the core 2 toward the outer side X1 in the radial direction X. The rear die 214 is a die for supporting the first outer circumferential surface 124 of the core 2 toward the inner side X2 in the radial direction X. The rear die 214 has a protrusion 27 to be fitted to the positioning groove 19 of the core 2. As shown in FIG. 10, the upper die 215 and the lower die 216 are respectively located on the upper and lower sides in the axial direction Y of the core 2.

An upper cavity 223 for integrally molding the upper wall 182, the lead-in/out portions 20, the outer flange 184, and the inner flange 185 of the insulation resin portion 4 on the upper side in the axial direction Y is formed between the upper die 215 and the upper surface 132 of the core 2. A lower cavity 224 for integrally molding the lower wall 183, the outer flange 184, and the inner flange 185 of the insulation resin portion 4 on the lower side in the axial direction Y is formed between the lower die 216 and the lower surface 133 of the core 2.

Further, the upper die 215 has a gate 26 for injecting melted insulation resin into the molding mold 21. The gate 26 is provided at a position on a plane middle line T of the core 2 shown in FIG. 9. In the case where the gate 26 is formed at this position, the injected insulation resin flows equally to right and left in the molding mold 21, and thus the molding condition becomes uniform between right and left. Desirably, the gate 26 is provided at a part other than a part where the winding body 8 is wound. This is because, if the gate is provided at a position where the winding body 8 is wound, there is a possibility that the winding body 8 cannot be wound regularly due to contact with burr after molding.

Next, an injection molding process using the molding mold 21 configured as described above will be described. The core 2 to which the insulation sheet 5 has been mounted is set to the rear die 214. At this time, the positioning groove 19 of the back yoke portion 12 of the core 2 is fitted to the corresponding protrusion 27 of the rear die 214, whereby the core 2 is positioned relative to the rear die 214.

Next, the remaining dies, i.e., right die 211, left die 212, front die 213, upper die 215, and lower die 216 are closed to clamp the molding mold 21. Along with this, the cavities 221, 222, 223, 224 for forming the insulation resin portion 4 are formed. For the purpose of enhancing workability in placement and extraction of the core 2, for example, the right die 211, the left die 212, and the upper die 215 are configured as slidable dies so as to be openable from the molding positions.

Next, melted insulation resin is injected through the gate 26 provided in the upper die 215 of the molding mold 21, to perform molding. Before the melted insulation resin is injected into the molding mold 21, the molding mold 21 may be heated in order to enhance fluidity of the insulation resin in the molding mold 21. The insulation resin flows from the gate 26 into the upper die 215 and then flows to branch into the right die 211 and the left die 212 and enter the lower die 216, thus filling the cavities 221, 222, 223, 224 formed in the molding mold 21. Thus, the insulation resin portion 4 is molded integrally with the insulation sheets 5 and the core 2 by the insulation resin. Next, after the insulation resin in the molding mold 21 is solidified, the molding mold 21 is opened and the molded stator piece 11 is extracted.

Thereafter, as necessary, burr generated in molding is removed by shot peening or the like. After the molding, a wire is wound on the insulation sheets 5 and the insulation resin portion 4 at the slot portions 6 of the stator piece 11, thus forming the winding body 8. Next, a plurality of the stator pieces 11 are arranged in an annular shape and retained by a jig, and a heated frame 3 is fitted thereto. Then, the plurality of stator pieces 11 arranged in an annular shape are fixed to the frame 3 by shrinkage-fit. As another fixation method, press-fitting to the frame 3 may be employed. Finally, wire connections between the plurality of winding bodies 8 and between an external current application cable and each winding body 8 are made. For example, the wire connections may be made by soldering using a lead wire, or ends of the winding bodies 8 may be connected by soldering to a printed board in which a wiring pattern is printed. Thus, the stator 10 is formed.

Here, in order to clarify the effect of the stator 10 according to embodiment 1, the stator 10 of embodiment 1 and a stator in a comparative example will be compared. FIG. 31 shows the structure of the stator in the comparative example. In the core in the comparative example, a first inner circumferential surface 322 is formed on the virtual plane S. Therefore, in the case where an outer flange 384 for covering the first inner circumferential surface 322 is formed at the same position as in the present disclosure, the flowing area of insulation resin is the same as the size of the outer flange 384 and thus is smaller as compared to embodiment 1, so that it is difficult to supply the insulation resin into the cavity for forming the outer flange 384. This problem is further significant in the case where a large number of sheet materials are stacked in the axial direction Y, because the flowing distance of the insulation resin increases and the flowing resistance of the insulation resin increases.

Therefore, in order to ensure fluidity of the insulation resin, the outer flange 384 needs to be formed so as to extend toward the inner side X2 in the radial direction X as compared to the present disclosure, e.g., to a position indicated by dotted lines in FIG. 31. In this case, the area of a slot portion 306 is reduced as compared to the present disclosure, so that the winding area is reduced. In particular, in a small-sized rotating electrical machine, the reduction rate of the winding area is great and the influence thereof becomes more significant.

In contrast, in the present embodiment 1, the first inner circumferential surface 122 of the first brim portion 121 of the back yoke portion 12 is formed by the undercut portion 17. Therefore, an area needed for the insulation resin to flow is ensured to be larger as compared to the comparative example. Thus, as compared to the comparative example, a larger area can be ensured for the slot portion 6 and a larger winding area can be ensured.

As described above, when the undercut portion 17 is formed to be larger, the area of the slot portion 6 becomes larger, and thus a larger winding area can be ensured. However, merely expanding the undercut portion 17 reduces performance of the rotating electrical machine. Therefore, a method for effectively forming the first inner circumferential surface 122 for forming the undercut portion 17 according to the present disclosure will be described.

During driving of the rotating electrical machine, when the winding body 8 is energized, a magnetic field is generated and a magnetic flux is concentrated on the core 2 which has high magnetic permeability. Most of the magnetic flux passes through the tooth portion 13 and the back yoke portion 12. An object has a limit on a magnetic flux that can pass through the inside thereof. Therefore, when the limit is reached, magnetic saturation occurs, so that the magnetic flux does not increase any more even if a stronger magnetic field is applied. The magnetic flux amount when magnetic saturation occurs is in proportion to the width of the magnetic path. Therefore, if the width of the magnetic path is narrowed, the properties of the rotating electrical machine are deteriorated.

In the core 2 in the present embodiment 1, a part where the magnetic path is narrow is the abutting end 15. Therefore, as shown in FIG. 6, if a width W1 in the radial direction X of the first brim portion 121 is smaller than a width W2 in the radial direction X of the abutting end 15, the properties of the rotating electrical machine are deteriorated. Therefore, in order to suppress the influence of formation of the undercut portion 17 on the properties of the rotating electrical machine, it is desirable to set the width W1 of the first brim portion 121 to be equal to or greater than the width W2 of the abutting end 15 (W1≥W2). It is noted that the width W1 of the first brim portion 121 does not refer to only one part shown in the drawing but refers to all parts having widths in the radial direction X of the first brim portion 121. Therefore, the first brim portion 121 is formed so as to satisfy the above relationship at all the parts thereof. As long as the first brim portion 121 is formed so as to satisfy the above relationship, the width W1 of the first brim portion 121 may differ among the parts.

In the stator of the rotating electrical machine according to embodiment 1 configured as described above, the first inner circumferential surface on the inner side in the radial direction of the first brim portion of the back yoke portion is formed on the outer side in the radial direction with respect to the virtual plane. The insulation resin portion covers both end surfaces in the axial direction of the tooth portion, the first inner circumferential surface of the first brim portion, and the second outer circumferential surface on the outer side in the radial direction of the second brim portion, and is molded integrally with the tooth portion, the back yoke portion, and the insulation sheets. The winding body is formed by winding a wire around the tooth portion with the insulation sheets and the insulation resin portion interposed therebetween. Therefore, in molding of the insulation resin portion, insulation resin can flow through the undercut portion, to form the insulation resin portion, and the winding area in the slot portion formed by the back yoke portion and the tooth portion can be ensured to be large, whereby properties of the rotating electrical machine can be improved.

In addition, as compared to the width in the radial direction of the abutting end at the circumferential-direction end surface of the first brim portion of the back yoke portion, the widths in the radial direction of the other parts in the circumferential direction of the first brim portion are equal thereto or greater. Therefore, the first brim portion has no parts where the magnetic path is narrower than at the abutting end, and thus properties of the rotating electrical machine are not deteriorated.

In addition, since an adhesive agent is present between the insulation sheet and the core, the insulation sheet can be reliably mounted to the core.

In addition, as the insulation sheet, the one having thermal conductivity of 0.8 (W/mK) or greater can be used. In this case, the effect that heat generated in the rotating electrical machine is dissipated to outside of the rotating electrical machine via the insulation sheet can be increased.

In the above embodiment 1, the example in which the stator 10 is formed by fixing the divided stator pieces 11 to the frame 3 by shrinkage-fit has been shown. However, without limitation thereto, for example, the plurality of stator pieces 11 may be connected to each other in the circumferential direction Z by welding or the like, and the plurality of connected stator pieces 11 may be inserted into the frame 3. In addition, even in the case of employing a connected core in which ends in the circumferential direction Z of a plurality of cores 2 are connected to each other via thin portions, the same configuration as in the present embodiment 1 can be applied and the same effects can be obtained. This also applies to the following embodiments, and will not be described again.

Embodiment 2

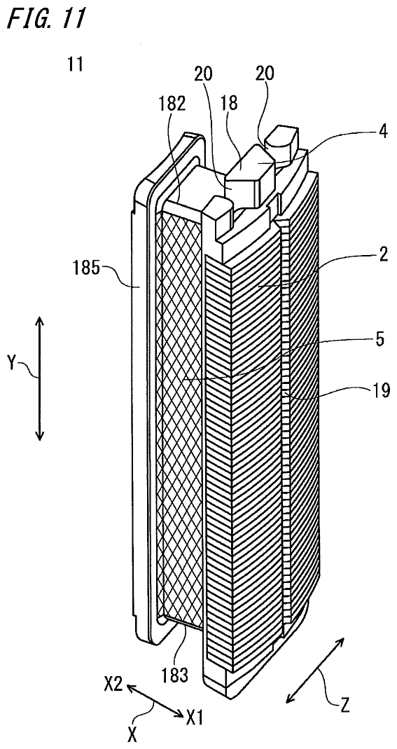

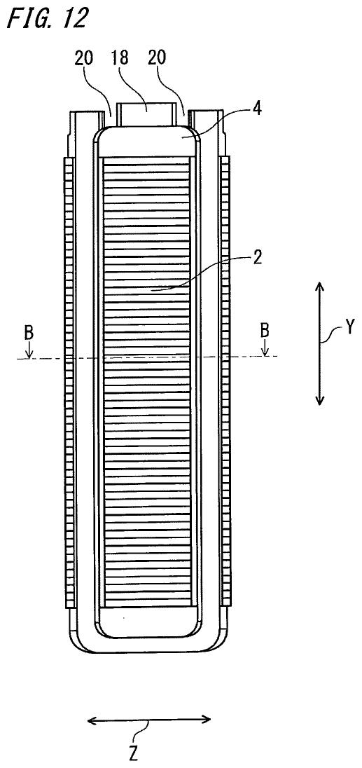

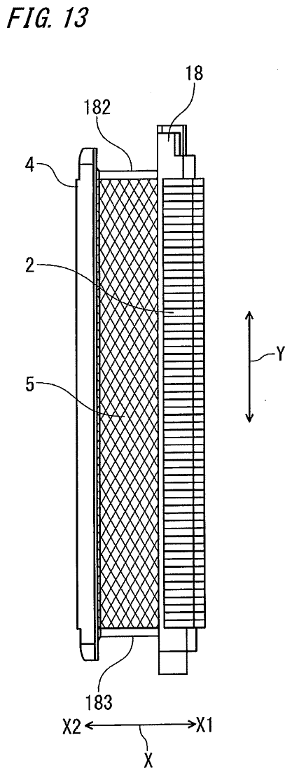

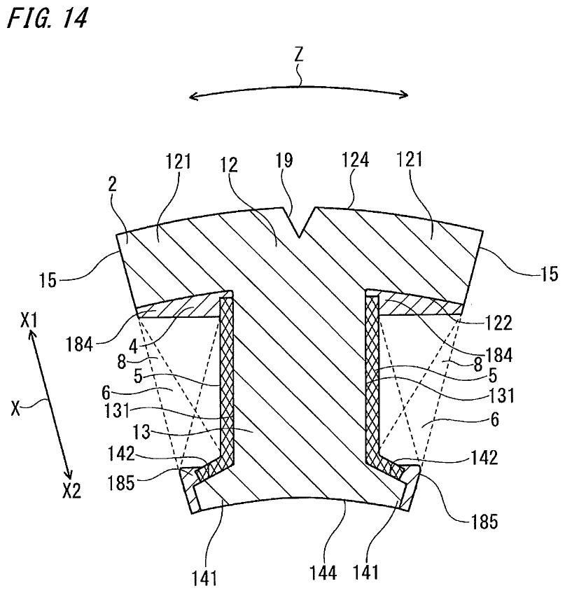

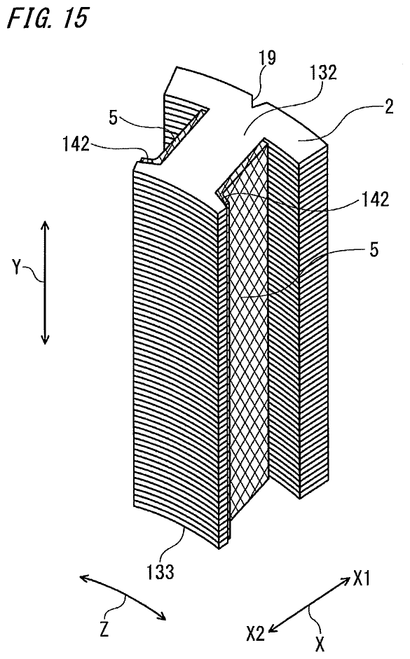

FIG. 11 is a perspective view showing the structure of a stator piece of a stator of a rotating electrical machine according to embodiment 2. FIG. 12 is a front view showing the structure of the stator piece shown in FIG. 11. FIG. 13 is a side view showing the structure of the stator piece shown in FIG. 11. FIG. 14 is a sectional view showing the structure of the stator piece shown in FIG. 12, taken along line B-B. FIG. 15 is a perspective view showing the structure in which insulation sheets are mounted to a core of the stator piece of the stator of the rotating electrical machine according to embodiment 2.

In the drawings, the same parts as those in the above embodiment 1 are denoted by the same reference characters, and the description thereof is omitted. The present embodiment 2 is different from the above embodiment 1 in that, as shown in FIG. 14, the insulation sheet 5 is mounted so as to extend and cover a part of the second outer circumferential surface 142 of the second brim portion 141 of the tooth portion 13 from the side surface 131 of the tooth portion 13. In addition, the inner flange 185 is connected to the insulation sheet 5 covering the second outer circumferential surface 142, and covers the insulation sheet 5.

Next, a method for manufacturing the stator of the rotating electrical machine according to embodiment 2 configured as described above will be described. The insulation sheet 5 is cut in predetermined dimensions from a predetermined material, and is shaped by being bent using a jig in advance so as to correspond to the side surface 131 of the tooth portion 13 and the second outer circumferential surface 142 of the second brim portion 141. Next, the insulation sheet 5 is attached to the core 2 by an adhesive agent or the like (see FIG. 15). The subsequent process is performed in the same manner as in the above embodiment 1, to form the insulation resin portion 4 and then form the stator 10.

In the above manufacturing method, the insulation sheet 5 made of a material on which a crease can be made is used. On the other hand, in the case of using the insulation sheet 5 made of a material on which a crease cannot be made, it is also possible to press the insulation sheet 5 by a jig so as to cover the side surface 131 and a part of the second outer circumferential surface 142 and bond the insulation sheet 5 to the core 2 by an adhesive agent. This method can be performed in the same manner also in the following embodiments, and will not be described again.

In the stator of the rotating electrical machine according to embodiment 2 configured as described above, in addition to the same effects as in the above embodiment 1, the following effects are obtained. The insulation sheet also covers a part of the second outer circumferential surface of the second brim portion, and the thickness of the insulation sheet is smaller than the thickness of the insulation resin portion. Therefore, the thickness of the part where the second outer circumferential surface of the second brim portion is covered is reduced, so that the winding area in the slot portion is further expanded, whereby properties of the rotating electrical machine can be further improved.

### Embodiment 3

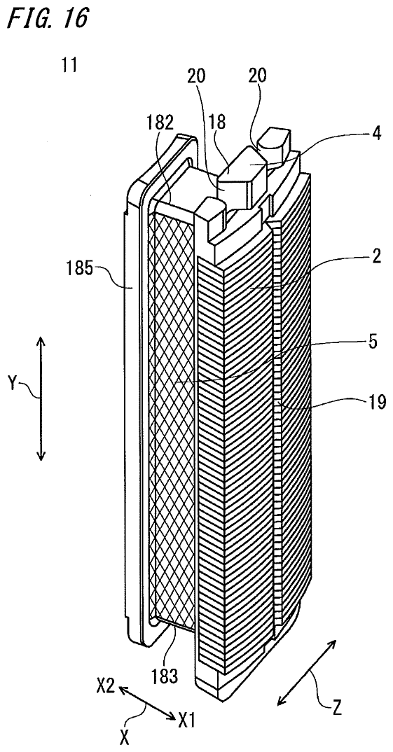

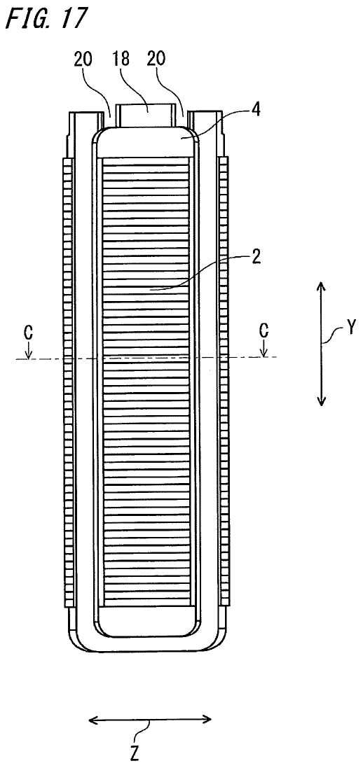

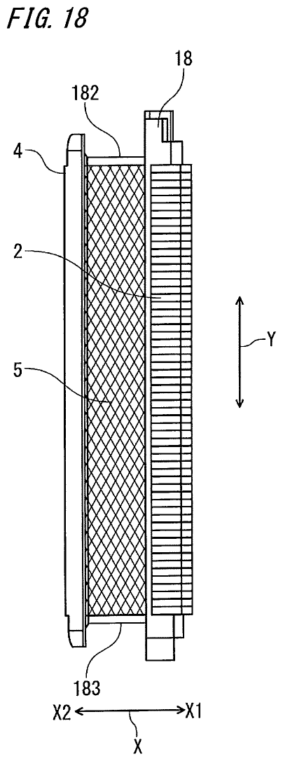

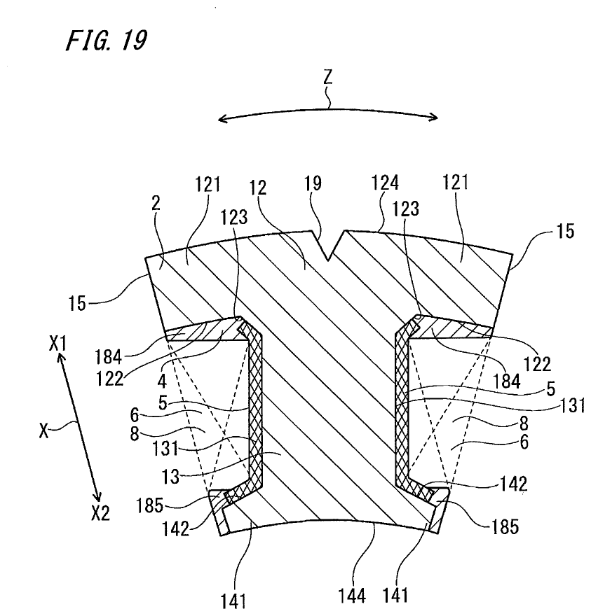

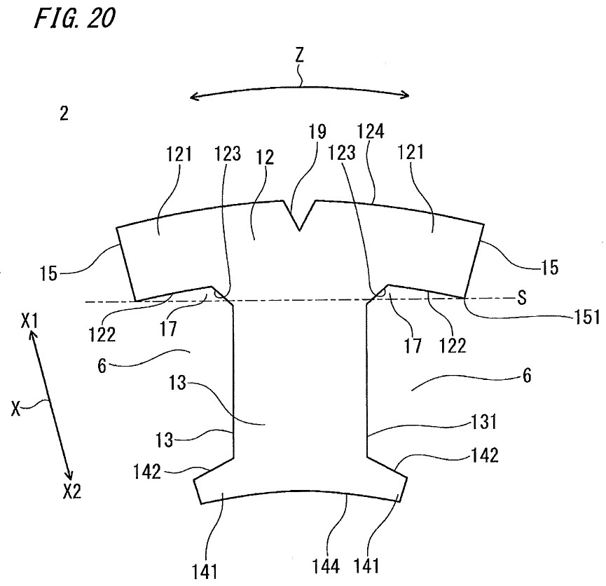

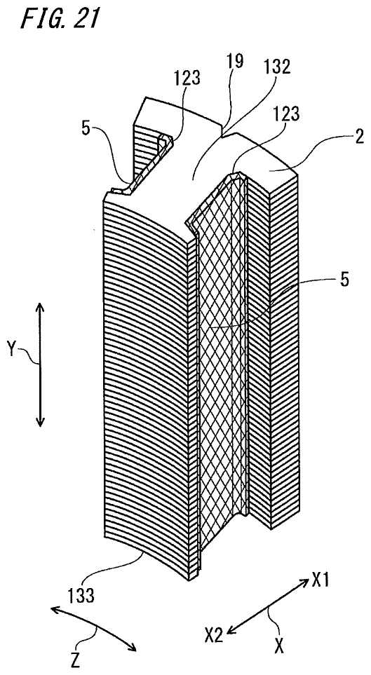

FIG. 16 is a perspective view showing the structure of a stator piece of a stator of a rotating electrical machine according to embodiment 3. FIG. 17 is a front view showing the structure of the stator piece shown in FIG. 16. FIG. 18 is a side view showing the structure of the stator piece shown in FIG. 16. FIG. 19 is a sectional view showing the structure of the stator piece shown in FIG. 17, taken along line C-C. FIG. 20 is a plan view showing the structure of the core of the stator piece shown in FIG. 16. FIG. 21 is a perspective view showing the structure in which insulation sheets are mounted to the core of the stator piece shown in FIG. 20.

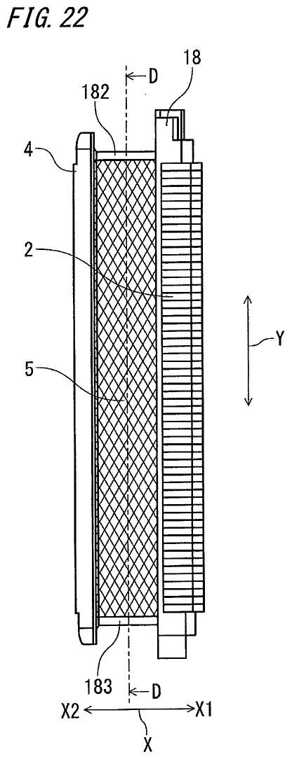

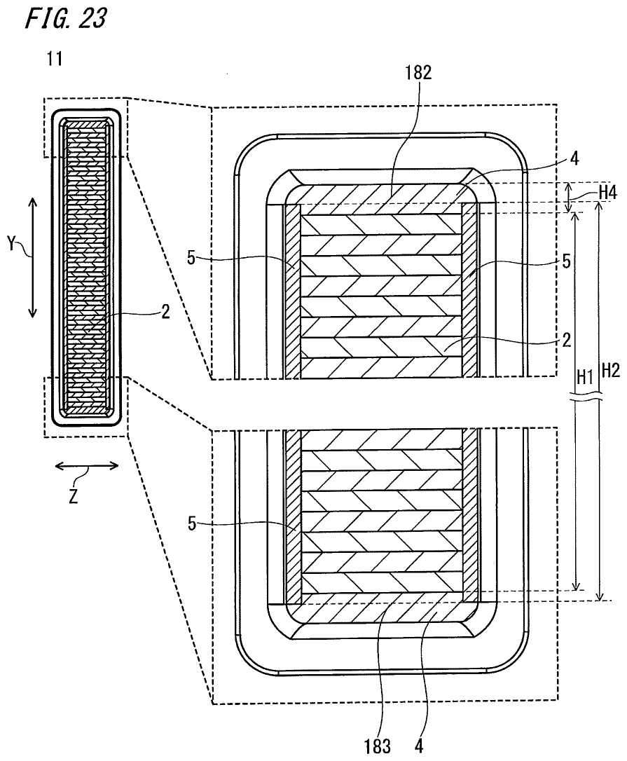

FIG. 22 is a side view showing another structure of the stator piece of the stator of the rotating electrical machine according to embodiment 3. FIG. 23 is a sectional view showing the detailed structure of the stator piece shown in FIG. 22, taken along line D-D. Further, FIG. 23 shows enlarged views of an upper end part and a lower end part in the axial direction Y of the stator piece.

In the drawings, the same parts as those in the above embodiments are denoted by the same reference characters, and the description thereof is omitted. The present embodiment 3 is different from the above embodiment 2 in that, as shown in FIG. 20, the back yoke portion 12 has a connection surface 123 connecting the first inner circumferential surface 122 and the side surface 131, to form the undercut portion 17. Further, as shown in FIG. 19, the insulation sheet 5 covers a part of the connection surface 123 in addition to the side surface 131 and a part of the second outer circumferential surface 142.

Next, a method for manufacturing the stator of the rotating electrical machine according to embodiment 3 configured as described above will be described. The insulation sheet 5 is cut in predetermined dimensions from a predetermined material, and is shaped by being bent using a jig in advance so as to correspond to the side surface 131 of the tooth portion 13, the second outer circumferential surface 142 of the second brim portion 141, and the connection surface 123. Next, the insulation sheet 5 is attached to the core 2 by an adhesive agent or the like (see FIG. 21). The subsequent process is performed in the same manner as in the above embodiment 1, to form the insulation resin portion 4 and then form the stator 10.

In the stator of the rotating electrical machine according to embodiment 3 configured as described above, in addition to the same effects as in the above embodiments, the following effects are obtained. The connection surface connecting the first inner circumferential surface of the first brim portion and the side surface of the tooth portion is formed, and the insulation sheet is mounted so as to extend and cover a part of the connection surface from the side surface of the tooth portion. Therefore, although the area of the undercut portion becomes smaller than in the above embodiments because of the presence of the connection surface, the width of the magnetic path through which a magnetic flux passes can be expanded. For example, in the case where rotating electrical machines of several sizes have the same common positioning groove formed on the back yoke portion, the proportion of the positioning groove area in the core is great in a rotating electrical machine of a small size. Therefore, the width of the magnetic path near the positioning groove becomes smaller than the width of the abutting end, and this can lead to deterioration in performance of the rotating electrical machine.

However, in the case where the connection surface is provided as in the present embodiment 3, the width of the magnetic path is expanded by the connection surface and a wide magnetic path can be ensured accordingly, whereby deterioration in performance of the rotating electrical machine can be prevented. In addition, since the width of the magnetic path is expanded by the connection surface, the positioning groove can be made greater accordingly. Thus, workability in positioning the core is improved.

In addition, since the insulation sheet is mounted on the connection surface, the length of the insulation sheet present in the outer flange is increased. Therefore, even if the position of the insulation sheet has deviated, the insulation sheet is less likely to come off from the outer flange. Thus, required accuracy in attachment of the insulation sheet can be decreased. In order to obtain insulation between two conductors against current flowing on the surface of an object, a certain distance is needed (hereinafter, the distance by which current flows on the surface of an object is referred to as “creeping distance”). In the present embodiment 3, the length of the insulation sheet embedded in the insulation resin portion is longer as compared to the above embodiment 1. Therefore, a path passing from the winding body through the surface of the insulation sheet to the core can be elongated, so that the creeping distance is elongated. Therefore, the present embodiment 3 can be applied to a high-voltage rotating electrical machine which requires a longer creeping distance as compared to the above embodiment 1.

However, at an end in the axial direction Y of the insulation sheet 5, an ensured creeping distance is only a distance corresponding to the thickness of the insulation sheet 5. Accordingly, as another example of the present embodiment 3, the insulation sheet 5 may be formed as shown in FIG. 22 and FIG. 23. As shown in the sectional view in FIG. 23, a length H2 in the axial direction Y of the insulation sheet 5 is set to be longer than a length H1 in the axial direction Y of the core 2, and both ends in the axial direction Y of the insulation sheet 5 are formed to be longer outward from both ends in the axial direction Y of the core 2. Thus, the creeping distance can be elongated and insulation property can be enhanced.

### Embodiment 4

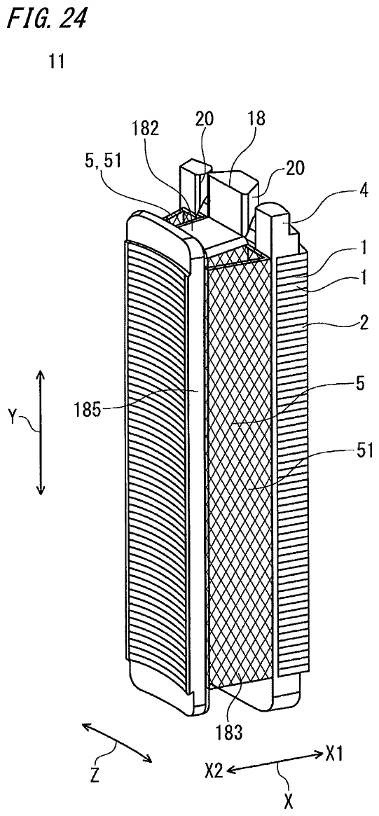

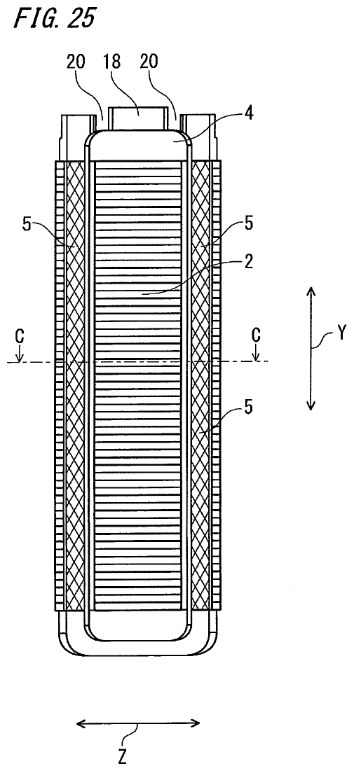

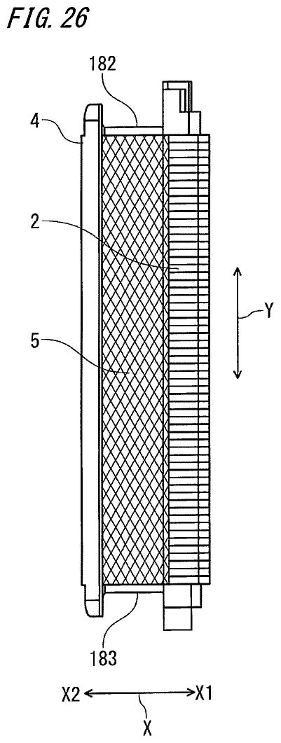

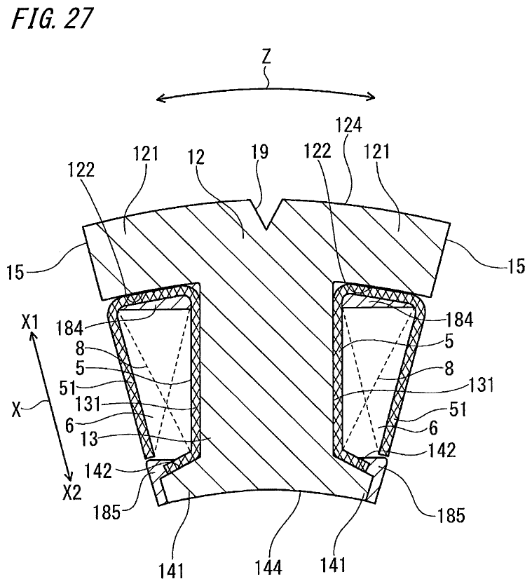

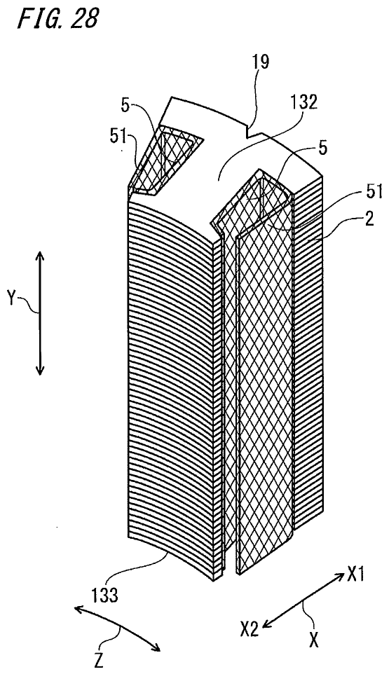

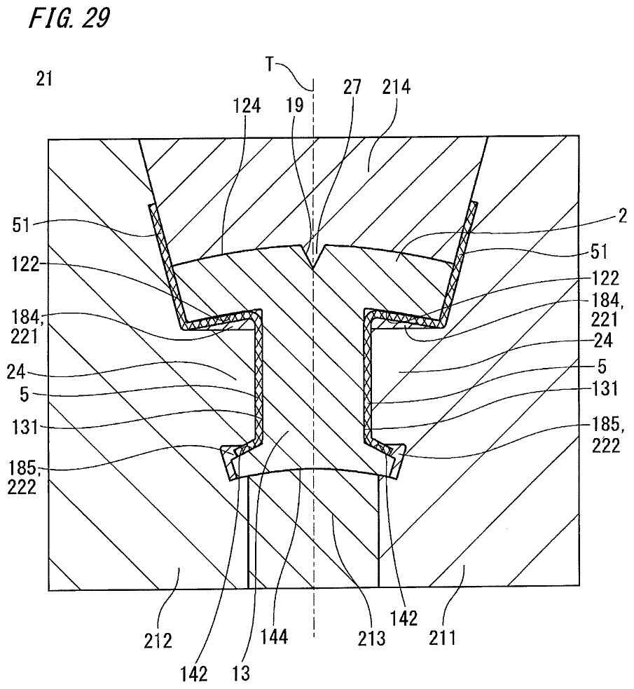

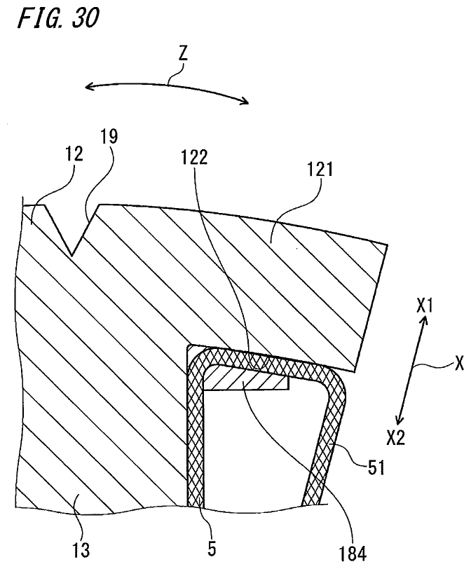

FIG. 24 is a perspective view showing the structure of a stator piece of a stator of a rotating electrical machine according to embodiment 4. FIG. 25 is a front view showing the structure of the stator piece shown in FIG. 24. FIG. 26 is a side view showing the structure of the stator piece shown in FIG. 24. FIG. 27 is a sectional view showing the structure of the stator piece shown in FIG. 25, taken along line C-C. FIG. 28 is a perspective view showing the structure in which insulation sheets are mounted to a core of the stator piece of the stator of the rotating electrical machine according to embodiment 5. FIG. 29 is a horizontal sectional view showing the structure of a molding mold used in a manufacturing method for the stator piece shown in FIG. 24. FIG. 30 is a sectional view showing the structure of a stator piece of a stator of a rotating electrical machine in another example of embodiment 5.

In the drawings, the same parts as those in the above embodiments are denoted by the same reference characters, and the description thereof is omitted. The present embodiment 4 is different from the above embodiment 2 in that, as shown in FIG. 27, the insulation sheet 5 is attached to a part of the second outer circumferential surface 142 and the first inner circumferential surface 122 in addition to the side surface 131. Further, the insulation sheet 5 has an inter-phase insulation portion 51 extending toward the inner side X2 in the radial direction X from an end in the circumferential direction Z of the part covering the first inner circumferential surface 122. The inter-phase insulation portion 51 of the insulation sheet 5 covers an exposed side in the circumferential direction Z of the winding body 8 wound in the slot portion 6. Thus, the inter-phase insulation portions 51 are located between the winding bodies 8 of the stator pieces 11 adjacent to each other.

Next, a method for manufacturing the stator of the rotating electrical machine according to embodiment 4 configured as described above will be described. The insulation sheet 5 is cut in predetermined dimensions from a predetermined material, and is shaped by being bent using a jig in advance so as to correspond to the side surface 131 of the tooth portion 13, the second outer circumferential surface 142 of the second brim portion 141, and the first inner circumferential surface 122 of the first brim portion 121. Next, the insulation sheet 5 is attached to the core 2 by an adhesive agent or the like. Next, the core 2 to which the insulation sheets 5 have been attached is inserted into the molding mold 21.

As shown in FIG. 29, the inter-phase insulation portions 51 of the insulation sheets 5 are located between the left die 212 and the rear die 214 and between the right die 211 and the rear die 214. Then, as in the above embodiments, the molding mold 21 is closed and clamped. Thus, the inter-phase insulation portions 51 of the insulation sheets 5 are held between the above parts in the molding mold 21. Subsequently, in this state, insulation resin is injected and molded to form the insulation resin portion 4, as in the above embodiments. In this case, as compared to the above embodiments, the cavity for forming the outer flange 184 is reduced by an amount corresponding to the thickness of the insulation sheet 5, but as compared to the above comparative example, the cavity can be ensured to be larger.

Next, with the insulation sheets 5 maintained in the state shown in FIG. 29, the stator piece 11 is extracted from the molding mold 21 and a wire is wound at the slot portions 6 of the stator piece 11, to form the winding body 8. Next, as shown in FIG. 27 and FIG. 28, the inter-phase insulation portions 51 of the insulation sheets 5 are bent to the slot portions 6, so as to cover exposed sides in the circumferential direction Z of the winding body 8, whereby the stator piece 11 is formed. Hereafter, the same process as in the above embodiments is performed to form the stator 10.

As another example, as shown in FIG. 30, the outer flange 184 is formed to be shorter on a side in the circumferential direction Z that is opposite to the tooth portion 13, than in the case shown FIG. 27 in the above embodiment 4. By forming the outer flange 184 in this way, the part where the flow path of resin is narrowed is eliminated, and thus flow of resin can be kept stable. In addition, even though the outer flange 184 is not formed at the above part, insulation between the stator pieces 11 can be ensured by the inter-phase insulation portions 51 of the insulation sheets 5. In addition, although it becomes difficult to regularly wind a wire at the part where the outer flange 184 is not formed, this part is on a side near the abutting end 15, i.e., corresponds to the last part of the winding wire. Therefore, even if the regularity is lost to a certain extent, a problem is less likely to occur.

In the case where the outer flange 184 is not formed at the above part, the part where the outer flange 184 is thin near the abutting end 15 is eliminated and thus molding of the outer flange 184 is stabilized. Therefore, the possibility that the outer flange 184 is cracked by a force of a wire being wound or a whisker-like part is formed to cause peeling can be eliminated, and thus the possibility that a foreign material arises in the rotating electrical machine can be eliminated.

In the present embodiment 4, the insulation resin portion 4 is not in direct contact with the first inner circumferential surface 122, but the outer flange 184 is connected to the upper wall 182 and the lower wall 183 and thus is retained by these parts.

In the stator of the rotating electrical machine according to embodiment 4 configured as described above, in addition to the same effects as in the above embodiments, the following effects are obtained. The inter-phase insulation portions of the insulation sheets make insulation between the winding bodies of the stator pieces adjacent to each other in the circumferential direction. Therefore, even if the winding conditions of the winding bodies are deteriorated due to manufacturing variations or the like, the winding bodies of the stator pieces adjacent to each other in the circumferential direction can be prevented from coming into contact with each other. Thus, required positioning accuracy of a device for winding a winding body can be reduced, and required working accuracy for a product can be reduced. In addition, since the insulation sheet having the inter-phase insulation portion for making insulation between the winding bodies adjacent to each other in the circumferential direction can be formed integrally in molding, the number of assembly steps can be decreased as compared to a method in which an insulation sheet between winding bodies adjacent to each other in the circumferential direction is mounted in a separate step.

### Embodiment 5

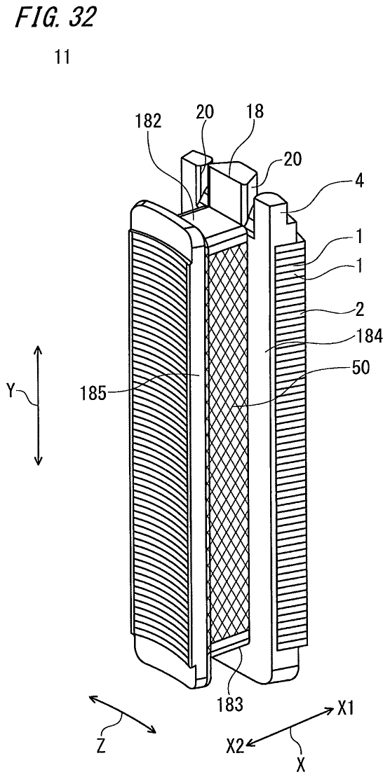

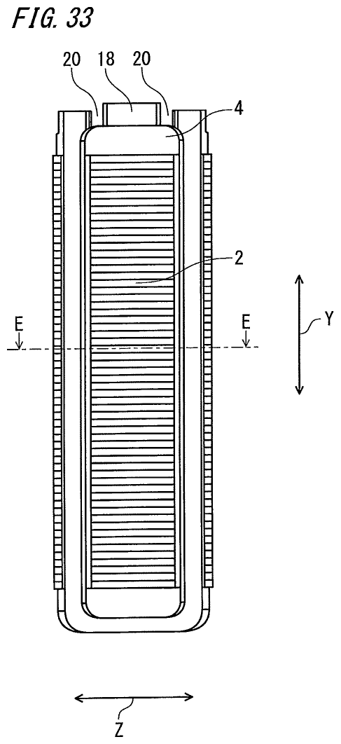

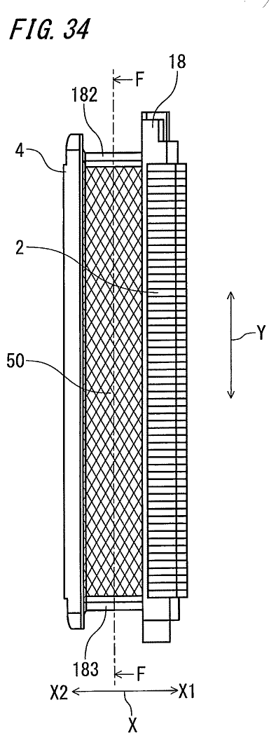

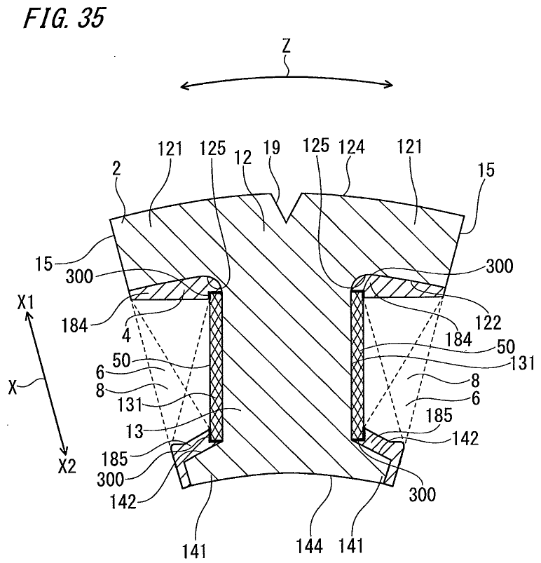

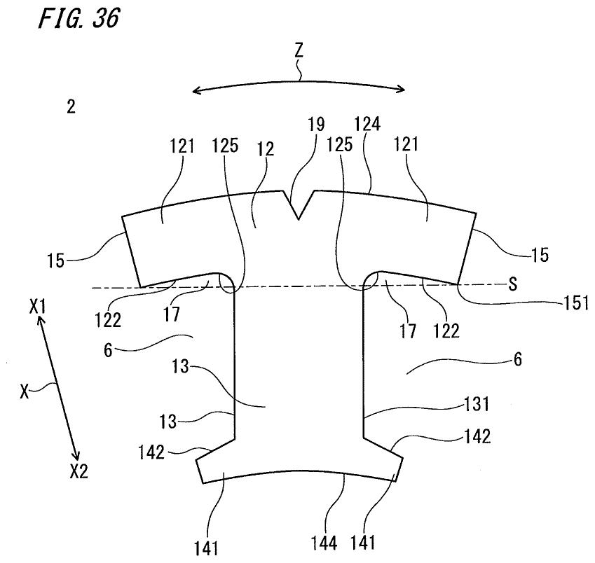

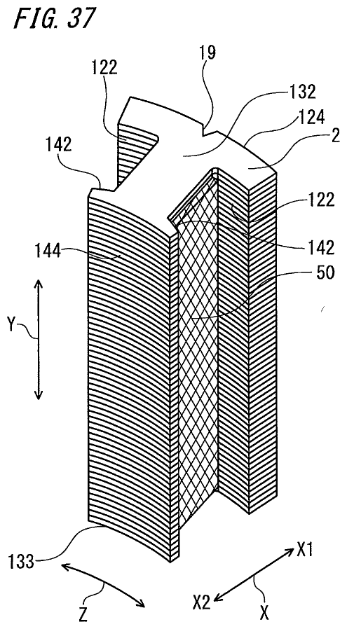

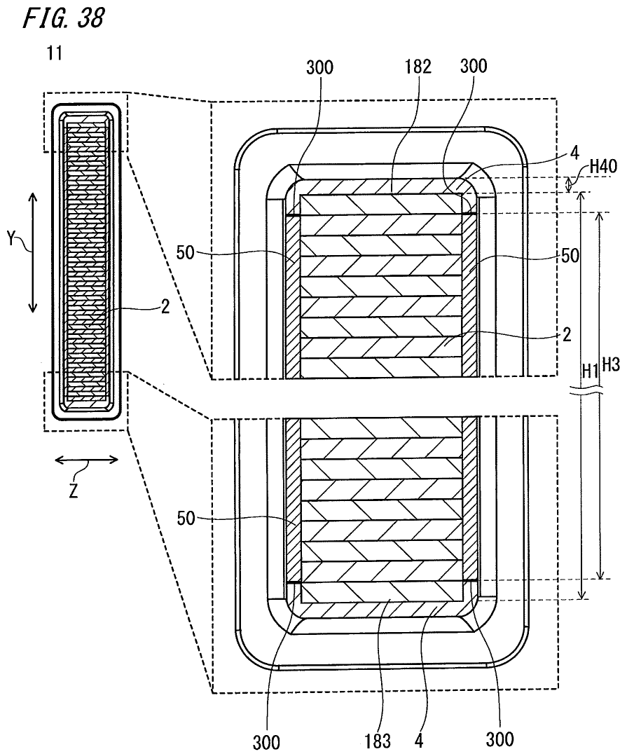

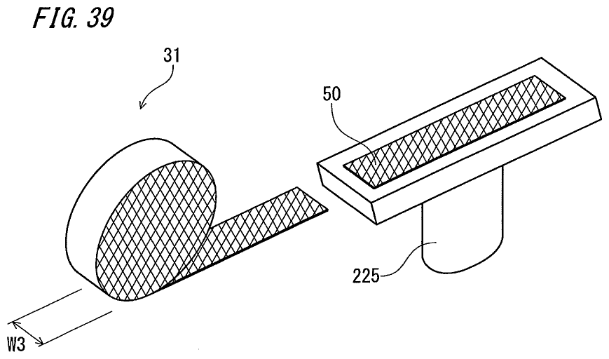

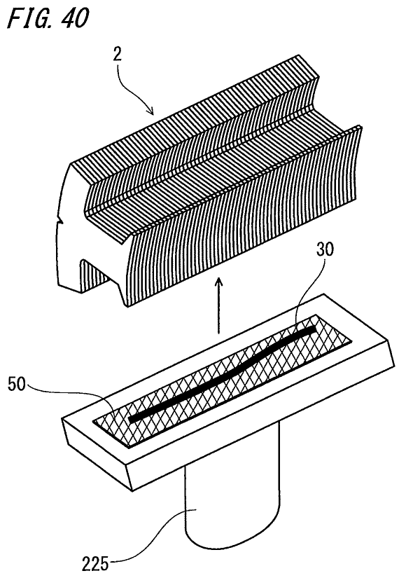

FIG. 32 is a perspective view showing the structure of a stator piece of a stator according to embodiment 5. FIG. 33 is a front view showing the structure of the stator piece shown in FIG. 32. FIG. 34 is a side view showing the structure of the stator piece shown in FIG. 32. FIG. 35 is a sectional view showing the structure of the stator piece shown in FIG. 33, taken along line E-E. FIG. 36 is a plan view showing the structure of a core of the stator piece shown in FIG. 32. FIG. 37 is a perspective view showing the structure in which insulation sheets are mounted to the core of the stator piece shown in FIG. 32. FIG. 38 is a sectional view showing the detailed structure of the stator piece shown in FIG. 34, taken along line F-F. FIG. 39 and FIG. 40 show a manufacturing method for the stator piece of the stator shown in FIG. 32.

In the drawings, the same parts as those in the above embodiments are denoted by the same reference characters, and the description thereof is omitted. A difference from the above embodiments is that, as shown in FIG. 36, in the back yoke portion 12, the connection surface 125 connecting the first inner circumferential surface 122 and the side surface 131 is formed in an arc shape, to form the undercut portion 17. Forming the connection surface 125 in an arc shape as described above expands the dimension in the radial direction X corresponding to the width dimension of the tooth portion 13 on the first brim portion 121 side where the magnetic flux is concentrated, thus obtaining an effect of relaxing saturation of the magnetic flux and improving torque of the rotating electrical machine.

In the above embodiment 3, as shown in FIG. 23, the length H2 in the axial direction Y of the insulation sheet 5 is set to be greater than the length H1 in the axial direction Y of the core 2. On the other hand, in the present embodiment 5, as shown in FIG. 38, a length H3 in the axial direction Y of the insulation sheet 50 is set to be smaller than a length H1 in the axial direction Y of the core 2. The insulation sheet 50 is made of a material equivalent to the insulation resin portion 4. Therefore, when the insulation resin portion 4 is formed, both of the insulation sheet 50 and the insulation resin portion 4 exceed their melting points and are melted, at the interface between the insulation sheet 50 and the insulation resin portion 4. Thus, at the interface between the insulation sheet 50 and the insulation resin portion 4, the insulation sheet 50 and the insulation resin portion 4 are mixed to form a melted-solidified layer 300 (see FIG. 35, FIG. 38). In particular, as shown in FIG. 38, the melted-solidified layer 300 can be formed at the interface between the insulation resin portion 4 and both upper and lower ends in the axial direction Y of the insulation sheet 50, where it is difficult to ensure a creeping distance required for insulation.

As shown in FIG. 35 and FIG. 38, the melted-solidified layers 300 are formed at all the parts corresponding to the interfaces between the insulation sheets 50 and the insulation resin portion 4. It is noted that, in FIG. 35 and FIG. 38, in order to clarify the parts where the melted-solidified layers 300 are formed, these parts are indicated by black thick lines, but the actual sizes (thicknesses) thereof are different.

As is found from comparison between FIG. 23 shown in the above embodiment 3 and FIG. 38 shown in the present embodiment 5, the thickness in the axial direction Y of the upper wall 182 formed at an end in the axial direction Y of the core 2 can be set such that a thickness H40 of the upper wall 182 shown in FIG. 38 is smaller than the thickness H4 of the upper wall 182 shown in FIG. 23.

Next, a method for manufacturing the stator of the rotating electrical machine according to embodiment 5 configured as described above will be described with reference to FIG. 39 and FIG. 40. As shown in FIG. 39, the insulation sheet 50 to be mounted to the core 2 is drawn in a predetermined dimension from a roll material 31 having a predetermined width W3, by using an adhesion pad 225, and then is cut by a cutter (not shown) and placed on the adhesion pad 225. The width W3 of the roll material 31 is equal to the width in the radial direction X of the insulation sheet 50 shown in FIG. 35.

An advantage in the case of using the roll material 31 as described above will be described. In the case of manufacturing several types of rotating electrical machines that are different in output and thus are different in the dimension in the axial direction Y of the stator piece 11, the insulation sheets 50 therefor vary only in the dimension in the axial direction Y, and the widths W3 thereof are the same. Therefore, even in the case of manufacturing rotating electrical machines having different outputs in the present embodiment 5, the roll material 31 having a width equal to the width W3 in the radial direction X of the insulation sheet 50 is used as described above. Thus, at the time of set-up change for production equipment, the roll material 31 need not be replaced, and the period in which the equipment is stopped when the machine type is switched can be reduced, whereby reduction of productivity can be suppressed. In addition, since the same roll material 31 can be used for different machine types, the order lot of the roll materials 31 can be increased and the material unit price can be reduced.

Next, as shown in FIG. 40, an adhesive agent 30 is applied on the insulation sheet 50 adhered by the adhesion pad 225, using an adhesive agent application device (not shown), and then the insulation sheet 50 is bonded to the side surface 131 of the core 2. It is noted that, if the insulation sheet 50 itself is adhesive, the step of applying the adhesive agent is not needed, and thus the manufacturing process can be simplified. The subsequent process is performed in the same manner as in the above embodiments, to form the insulation resin portion 4 and manufacture the stator piece 11 shown in FIG. 32.

In the present embodiment 5, as shown in FIG. 38, the length H3 in the axial direction Y of the insulation sheet 50 is set to be smaller than the length H1 in the axial direction Y of the core 2. Here, the insulation sheet 50 is made of a material equivalent to the insulation resin portion 4, and when the insulation resin portion 4 is formed, the interface between the insulation sheet 5 and the insulation resin portion 4 is melted and solidified to form the melted-solidified layer 300. Therefore, the length H2 in the axial direction Y of the insulation sheet 5 need not be set to be greater than the length H1 in the axial direction Y of the core 2 in order to ensure the creeping distance as in the above embodiment 3.

Thus, as shown in FIG. 38, the thickness H40 in the axial direction Y of the upper wall 182 can be set to be smaller than the thickness H4 in the axial direction Y of the upper wall 182 shown in FIG. 23 in the above embodiment 3. Therefore, the revolution length of the winding body 8 wound around the stator piece 11 can be shortened, whereby copper loss is suppressed and size reduction and efficiency improvement of the rotating electrical machine can be achieved.

In the stator of the rotating electrical machine according to embodiment 5 configured as described above, in addition to the same effects as in the above embodiments, the following effects are obtained. Since the length in the axial direction of the insulation sheet is shorter than the length in the axial direction of the core, the thicknesses in the axial direction of the insulating resin members provided at both ends in the axial direction of the core can be made small. Thus, the revolution length of the winding body wound around the stator piece can be shortened, whereby copper loss is suppressed and size reduction and efficiency improvement of the rotating electrical machine can be achieved.

At the interface between the insulation sheet and the insulation resin portion, the melted-solidified layer is formed. Therefore, it is not necessary to ensure the creeping distance, and the amount of the used insulation sheet can be minimized, leading to cost reduction.

In the present embodiment 5, the insulation sheet 50 is made of a material equivalent to the insulation resin portion 4, and the melted-solidified layer 300 in which the insulation sheet 50 and the insulation resin portion 4 are melted and mixed is formed at the interface between the insulation sheet 50 and the insulation resin portion 4.

However, the method for forming the melted-solidified layer is not limited thereto. Even in the case where the insulation sheet 50 and the insulation resin portion 4 have different melting points and the insulation sheet 50 and the insulation resin portion 4 are not mixed at the interface therebetween, if one of the insulation sheet 50 and the insulation resin portion 4 is melted at the interface therebetween, a gap between the insulation sheet 50 and the insulation resin portion 4 is eliminated and the melted-solidified layer 300 making close contact therebetween is formed, whereby the same effects can be obtained.

That is, although not specifically shown in the above embodiments, for example, as shown in FIG. 9, in the case where the insulation resin portion 4 is molded, the insulation resin portion 4 is melted and formed. Thus, at the interface between the insulation sheet and the insulation resin portion, a gap between the insulation sheet and the insulation resin portion is eliminated and the melted-solidified layer making close contact therebetween is formed, whereby the same effects can be obtained. However, as a matter of course, it can be said that the melted-solidified layer 300 in which the insulation sheet 50 and the insulation resin portion 4 are melted and mixed has more excellent insulation property.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

### DESCRIPTION OF THE REFERENCE CHARACTERS

1 sheet material
2 core
3 frame
4 insulation resin portion
5 insulation sheet
6 slot portion
8 winding body
10 stator
11 stator piece
12 back yoke portion
13 tooth portion
15 abutting end
17 undercut portion
18 winding frame portion
19 positioning groove
20 lead-in/out portion
21 molding mold
26 gate
27 protrusion
31 roll material
50 insulation sheet
51 inter-phase insulation portion
121 first brim portion
122 first inner circumferential surface
124 first outer circumferential surface
123 connection surface
125 connection surface
131 side surface
132 upper surface
133 lower surface
141 second brim portion
142 second outer circumferential surface
144 second inner circumferential surface
151 end point
152 intersection
182 upper wall
183 lower wall
184 outer flange
185 inner flange
211 right die
212 left die
213 front die
214 rear die
215 upper die
216 lower die
221 outer cavity
222 inner cavity
223 upper cavity
224 lower cavity
225 adhesion pad
300 melted-solidified layer
H1 length
H2 length
H3 length
H4 thickness
H40 thickness
S virtual plane
T plane middle line
W1 width
W2 width
W3 width
X radial direction
X1 outer side
X2 inner side
Y axial direction
Z circumferential direction

1. A stator of a rotating electrical machine, comprising a plurality of stator pieces arranged in an annular shape, the stator pieces each having a core, a winding body, and insulation sheets and an insulation resin portion that insulate the core and the winding body from each other, wherein
the core is formed by stacking a plurality of sheet materials in an axial direction of a rotary shaft of the rotating electrical machine, and has a back yoke portion and a tooth portion,
the back yoke portion forms an outer circumferential part of the stator and has first brim portions protruding in a circumferential direction,
the tooth portion protrudes inward in a radial direction from the back yoke portion and has, at an end on an inner side in the radial direction, second brim portions protruding in the circumferential direction,
in a cross section perpendicular to the rotary shaft of the rotating electrical machine, with a virtual plane defined as a plane that passes through end points on an inner side in the radial direction of circumferential-direction end surfaces of the first brim portions of the back yoke portion and is perpendicular to side surfaces on both sides in the circumferential direction of the tooth portion, first inner circumferential surfaces on an inner side in the radial direction of the first brim portions of the back yoke portion are formed on an outer side in the radial direction with respect to the virtual plane, except for the end points,
the insulation sheets are mounted to the side surfaces of the tooth portion,
the insulation resin portion covers both end surfaces in the axial direction of the tooth portion, the first inner circumferential surfaces of the first brim portions, and second outer circumferential surfaces on an outer side in the radial direction of the second brim portions, and is molded integrally with the tooth portion, the back yoke portion, and the insulation sheets, and
the insulation resin portion or the insulation sheets are located at undercut portions formed between the virtual plane and the first inner circumferential surfaces, and
the winding body is formed by winding a wire around the tooth portion with the insulation sheets and the insulation resin portion interposed therebetween.

2. The stator of the rotating electrical machine according to claim 1, wherein
each first brim portion of the back yoke portion is formed such that a width thereof in the radial direction other than the circumferential-direction end surface of the first brim portion is equal to or greater than a width in the radial direction of the circumferential-direction end surface of the first brim portion.

3. The stator of the rotating electrical machine according to claim 1,
each insulation sheet is mounted so as to extend and cover a part of the second outer circumferential surface of the second brim portion of the tooth portion from the side surface of the tooth portion.

4. The stator of the rotating electrical machine according to claim 1, wherein
the back yoke portion has a connection surface connecting the first inner circumferential surface of each first brim portion and the corresponding side surface of the tooth portion, and
each insulation sheet is mounted so as to extend and cover a part of the connection surface from the side surface of the tooth portion.

5. The stator of the rotating electrical machine according to claim 1, wherein
each insulation sheet covers the first inner circumferential surface of the first brim portion from the side surface of the tooth portion, and has an inter-phase insulation portion extending in the radial direction from an end in the circumferential direction of the first inner circumferential surface.

6. The stator of the rotating electrical machine according to claim 1, wherein
a length in the axial direction of each insulation sheet is greater than a length in the axial direction of the core.

7. The stator of the rotating electrical machine according to any one claim 1, wherein
a length in the axial direction of each insulation sheet is smaller than a length in the axial direction of the core.

8. The stator of the rotating electrical machine according to claim 1, wherein
an adhesive agent is provided between each insulation sheet and the core.

9. The stator of the rotating electrical machine according to claim 1, wherein
a melted-solidified layer is formed at an interface between each insulation sheet and the insulation resin portion.

10. The stator of the rotating electrical machine according to claim 1, wherein
a thermal conductivity of each insulation sheet is equal to or greater than a thermal conductivity of a material of the insulation resin portion.

11. A method for manufacturing the stator of the rotating electrical machine according to claim 1, the method comprising the steps of:
stacking the sheet materials in the axial direction to form the core;
mounting the insulation sheets to the core;
molding insulation resin integrally with the core and the insulation sheets to form the insulation resin portion; and
winding the wire around the tooth portion to form the winding body.

12. The stator of the rotating electrical machine according to claim 2, wherein
each insulation sheet is mounted so as to extend and cover a part of the second outer circumferential surface of the second brim portion of the tooth portion from the side surface of the tooth portion.

13. The stator of the rotating electrical machine according to claim 2, wherein
the back yoke portion has a connection surface connecting the first inner circumferential surface of each first brim portion and the corresponding side surface of the tooth portion, and
each insulation sheet is mounted so as to extend and cover a part of the connection surface from the side surface of the tooth portion.

14. The stator of the rotating electrical machine according to claim 3, wherein
the back yoke portion has a connection surface connecting the first inner circumferential surface of each first brim portion and the corresponding side surface of the tooth portion, and
each insulation sheet is mounted so as to extend and cover a part of the connection surface from the side surface of the tooth portion.

15. The stator of the rotating electrical machine according to claim 2, wherein
each insulation sheet covers the first inner circumferential surface of the first brim portion from the side surface of the tooth portion, and has an inter-phase insulation portion extending in the radial direction from an end in the circumferential direction of the first inner circumferential surface.

16. The stator of the rotating electrical machine according to claim 3, wherein
each insulation sheet covers the first inner circumferential surface of the first brim portion from the side surface of the tooth portion, and has an inter-phase insulation portion extending in the radial direction from an end in the circumferential direction of the first inner circumferential surface.

17. The stator of the rotating electrical machine according to claim 4, wherein
each insulation sheet covers the first inner circumferential surface of the first brim portion from the side surface of the tooth portion, and has an inter-phase insulation portion extending in the radial direction from an end in the circumferential direction of the first inner circumferential surface.

18. The stator of the rotating electrical machine according to claim 2, wherein
a length in the axial direction of each insulation sheet is greater than a length in the axial direction of the core.

19. The stator of the rotating electrical machine according to claim 2, wherein
a length in the axial direction of each insulation sheet is smaller than a length in the axial direction of the core.

20. The stator of the rotating electrical machine according to claim 2, wherein
an adhesive agent is provided between each insulation sheet and the core.
